(19) United States
(12) Patent Application Publication
(10) Pub. No.: US 2015/0062660 A1
(43) Pub. Date: Mar. 5, 2015

(54) FILE MANAGEMENT APPARATUS AND FILE MANAGEMENT METHOD

(71) Applicants: TOSHIBA TEC KABUSHIKI KAISHA, Tokyo (JP); KABUSHIKI KAISHA TOSHIBA, Tokyo (JP)

(72) Inventor: Yuichi Kato, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 14/014,691

(22) Filed: Aug. 30, 2013

(51) Int. Cl. G06F 17/30; H04N 1/21

(52) U.S. Cl. CPC G06F 17/3028; H04N 1/2179; G06F 17/30011; G06F 17/3012; H04N 2201/0094; H04N 2201/0081
USPC 358/403

(57) ABSTRACT

In accordance with one embodiment, a file management apparatus for managing a file name of a file of an image information includes a title name extraction section configured to extract a plurality of different individual title names, a combined title name generation section configured to combine the plurality of individual title names extracted by the title name extraction section to generate a combined title name, an individual title name selection section configured to select one individual title name from the plurality of individual title names extracted by the title name extraction section, a file name determination section configured to select processes which determine the combined title name generated by the combined title name generation section as a file name or processes which determine the individual title name selected by the individual title name selection section as a file name and add the determined file name to the original image information.

### FIELD

Embodiments described herein relate to a technology for managing a file read by a scanner.

### BACKGROUND

Conventionally, the original information read by a scanner is stored in, for example, an internal memory of an MFP (Multi Function Peripheral) provided with a scanner or a recording section of an external server and the like, and is sometimes attached to a mail and sent by a mail function.

A file management apparatus is proposed which automatically adds a file name to the original information read by a scanner in the case where the original information is stored in a recording section and in the case where the original information is attached to a mail.

Such a file management apparatus generates a plurality of file names based on, for example, the read original information and a predetermined naming rule, and adds a file name selected from the plurality of file names to the original information (JPA2009-205325). Further, other file management apparatuses extract the information of an area surrounded by margin from the read original information and set the extracted data as a file name (JPA2006-252455).

However, the file name needs to be rewritten manually by a user if the automatically added file name is not suitable.

### BRIEF DESCRIPTION OF THE DRAWINGS

FIG. 1 is a diagram illustrating a constitution relating to a file management of an MFP according to an embodiment;

FIG. 2 is a diagram illustrating a file management display screen of an operation section of FIG. 1;

FIG. 3 is a diagram illustrating the reading on the title of a read original; and

FIG. 4 is a flowchart illustrating a file name determination process.

### DETAILED DESCRIPTION

A file management apparatus according to the embodiment is a file management apparatus for managing a file name of a file of an image information based on the information of an original image read by a scanner unit.

The file management apparatus comprises an image processing section configured to carry out an image processing for the original image information read by the scanner unit, a title name extraction section configured to extract a plurality of different individual title names based on the processing information processed by the image processing section, a combined title name generation section configured to combine the plurality of individual title names extracted by the title name extraction section to generate a combined title name, an individual title name selection section configured to select one individual title name from the plurality of individual title names extracted by the title name extraction section, a file name determination section configured to select processes which determine the combined title name generated by the combined title name generation section as a file name or processes which determine the individual title name selected by the individual title name selection section as a file name and add the determined file name to the original image information and a storage section configured to store the original image information added with the determined file name.

A file management method according to the embodiment is a file management method for managing a file name of a file of an image information based on the information of an original image read by a scanner unit.

The file management method includes carrying out an image processing for the original image information read by the scanner unit, extracting a plurality of different individual title names based on the processed information, combining the plurality of extracted individual title names to generate a combined title name, selecting one individual title name from the plurality of extracted individual title names, selecting processes which determine the generated combined title name as a file name or processes which determine the selected individual title name as a file name and adding the determined file name to the original image information and storing the original image information added with the determined file name.

The file management apparatus according to the present embodiment is described below with reference to the accompanying drawings.

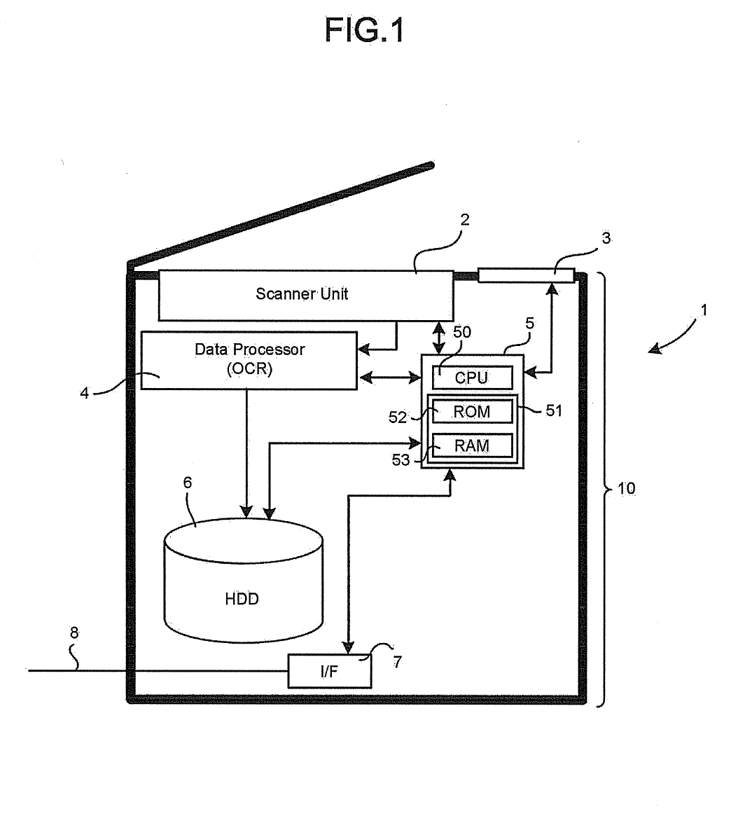

FIG. 1 illustrates a system constitution relating to a file management of an MFP 1. The MFP 1 having a print function, a mail function and a facsimile function comprises a file management apparatus 10 for adding a file name to the image data read by a scanner unit 2 when the image data is stored in a storage section 6.

The file management apparatus 10 comprises a scanner unit 2 for reading an image of an original; an operation section 3 for carrying out an operation such as a file management setting; a data processor 4 for processing the image read by the scanner unit 2; a control section 5 for controlling the whole MFP 1, including the file management apparatus 10 which determines a file name based on the title information read by the data processor 4; a storage section (HDD) 6 for storing the image information processed by the data processor 4; and a communication interface 7 connected with a network 8.

The data processor 4 has an OCP (Optical Character Reader) function and stores the read image in the storage section 6.

The control section 5 executes a specified file management processing based on a file management program stored in a memory section 51 or the storage section 6 and controls a file management operation.

The control section 5 has a processor 50 consisting of, for example, a CPU (Central Processing Unit) or an MPU (Micro Processing Unit) and the memory 51. The memory 51, which is, for example, a semiconductor memory, comprises a ROM (Read Only Memory) 52 for storing various control programs and a RAM (Random Access Memory) 53 for providing a temporary working area for the processor 50. For example, the ROM 52 stores a sorting template (which will be described later) for associating a file name with the content of a file and programs of a first and a second modes for determining a title name. The RAM 53 temporarily stores a title name read by the data processor 4.

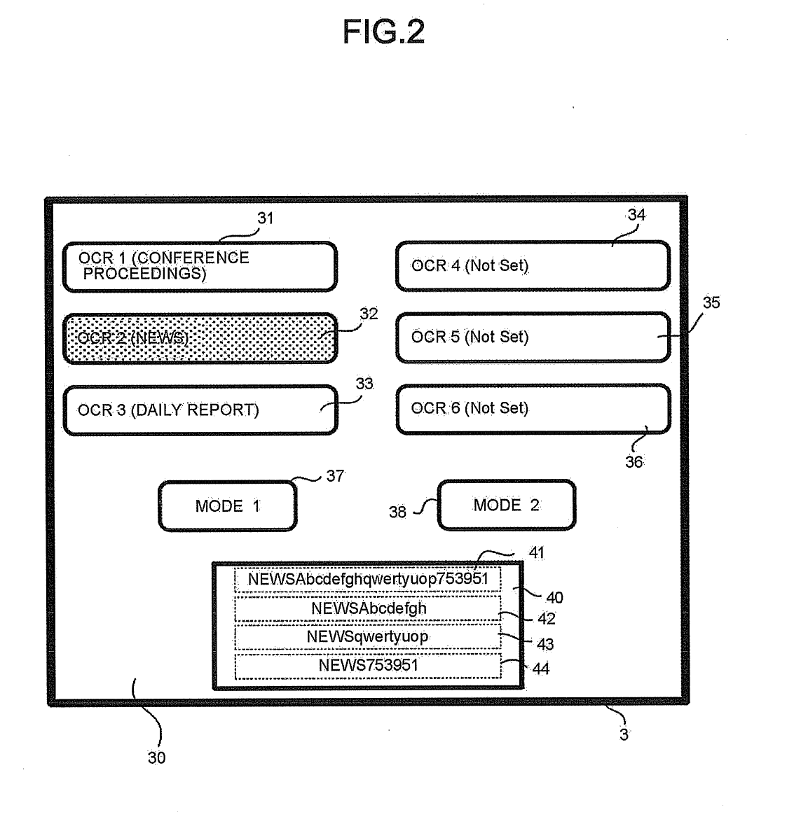

As shown in FIG. 2, the operation section 3 comprises, for example, a touch panel type operation display section 30.

A plurality of template display sections 31-36 for displaying attributions of file names, a first mode selection section 37 for selecting a first file determination mode, a second mode selection section 38 for selecting a second file determination mode and a title name display section 40 are arranged on the operation display section 30.

In FIG. 2, as an attribution, a sorting title name ‘CONFERENCE PROCEEDINGS’ is displayed on the first template display section 31, a sorting title name ‘NEWS’ is displayed on the second template display section 32, and a sorting title name ‘DAILY REPORT’ is displayed on the third template display section 33. Further, characters ‘Not Set’ are displayed on the fourth to the sixth template display sections 34-36 as an attribution. The sorting title names of the template display sections are written freely and are rewritable. Consequentially, the sorting title name of a template display section is selected when the template display section is touched.

In the storage section 6, folders are respectively generated corresponding to the sorting title names of each template display section 31-36. Thus, a file added with the sorting title name of a template is stored in a folder corresponding to the sorting title name.

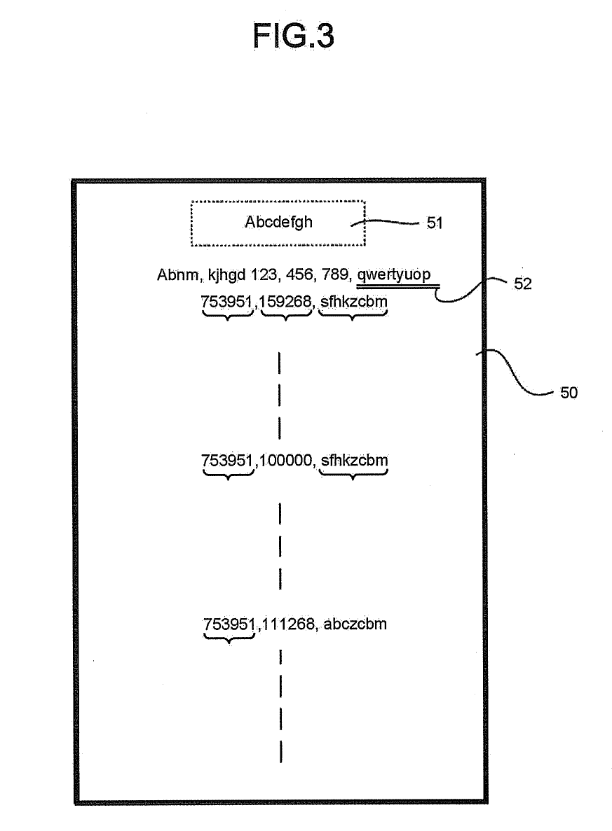

The display mode of the title name display section 40 is described with reference to FIG. 3.

FIG. 3 illustrates a first page of an original 50 read by the scanner unit 2. In FIG. 3, a first title setting area 51 represented by a dashed line is set in the data processor 4 in advance. The data processor 4 reads the characters in the first title setting area 51 using the OCR function and stores the read characters in the RAM 53 of the memory section 51. The title read from the first title setting area 51 is set to be a first title. In FIG. 3, ‘Abcdefgh’ is determined as a first title name. Further, a given number characters which are read initially may be set as a first title without using the first title setting area 51.

On the first page of the original 50, a user draws, with a pen, a second title setting area 52 represented with double underlines. The data processor 4 reads the characters displayed in the second title setting area 52 and stores the read characters in the RAM 53. The title read from the second title setting area 52 is set to be a second title. In FIG. 3, ‘qwertyuop is determined as a second title.

Further, the processor 50 counts the numerals or the characters in, for example, one page processed by the data processor 4, and stores a character with the highest frequency in the RAM 53 as the third title. In FIG. 3, numerals ‘753951’ are automatically determined as the third title. Herein, the title names of the first title, the second title and the third title are different from each other. If the title name of the third title is the same as that of the first or second title, then a character with the second highest frequency, for example, the ‘sfhkzcbm’ in FIG. 3, is determined as the third title.

The control section 5 combines the first title, the second title and the third title in sequence to generate a combined title name. Further, in the case where a sorting title name is selected, the combined title name is a name started with the sorting title name.

Then, the combined title name is displayed on a combined title name display section 41 of the title name display section 40. It is exemplarily shown in FIG. 2 that the second template display section 32 is selected, and the ‘NEWS’ as a sorting title name and the following ‘Abcdefghqwertyuop753951’ as a combined title name are displayed on the combined title name display section 41.

In the present embodiment, the scanner unit 2 starts to scan when the template display sections 31-36 are touched. In this case, the combined title name is displayed without a sorting title name if a template display section on which characters ‘not set’ are displayed is touched.

Further, a first individual title display section 42, a second individual title display section 43 and a third individual title display section 44 are set on the title name display section 40. Moreover, the control section 5 respectively displays the characters of the first title, the second title and the third title on the first individual title display section 42, the second individual title display section 43 and the third individual title display section 44.

Herein, if the combined title displayed on the combined title name display section 41 is determined to be a file name, the first mode selection section 37 is touched to select the first mode. Additionally, the first mode can also be selected by touching the combined title name display section 41 instead of touching the first mode selection section 37. Before the scanner unit 2 starts to read, the individual display of title names on the first individual title display section 42, the second individual title display section 43 and the third individual title display section 44 can be stopped if the first mode selection section 37 is selected.

On the other hand, the second mode determines one of the title names of the first title, the second title and the third title as a file name, and the second mode is selected by touching the second mode selection section 38. Then, a user selects a desired title name from the title names displayed on the first individual title display section 42, the second individual title display section 43 and the third individual title display section 44. A file name is determined by touching the display section on which the desired title name is displayed. In this case, if a sorting title name is set selecting the template display section, then the sorting title name is placed in front of the individual title name. In FIG. 2, ‘NEWSAbcdefgh’ is displayed on the first individual title display section 42, ‘NEWSqwertyuop’ is displayed on the second individual title display section 43 and ‘NEWSA753951’ is displayed on the third individual title display section 44.

If a file name is determined by the first or second mode, then the determined file name is stored in the storage section 6 as the file name of the image data. Further, the image data may also be stored in an external server via the I/F 7.

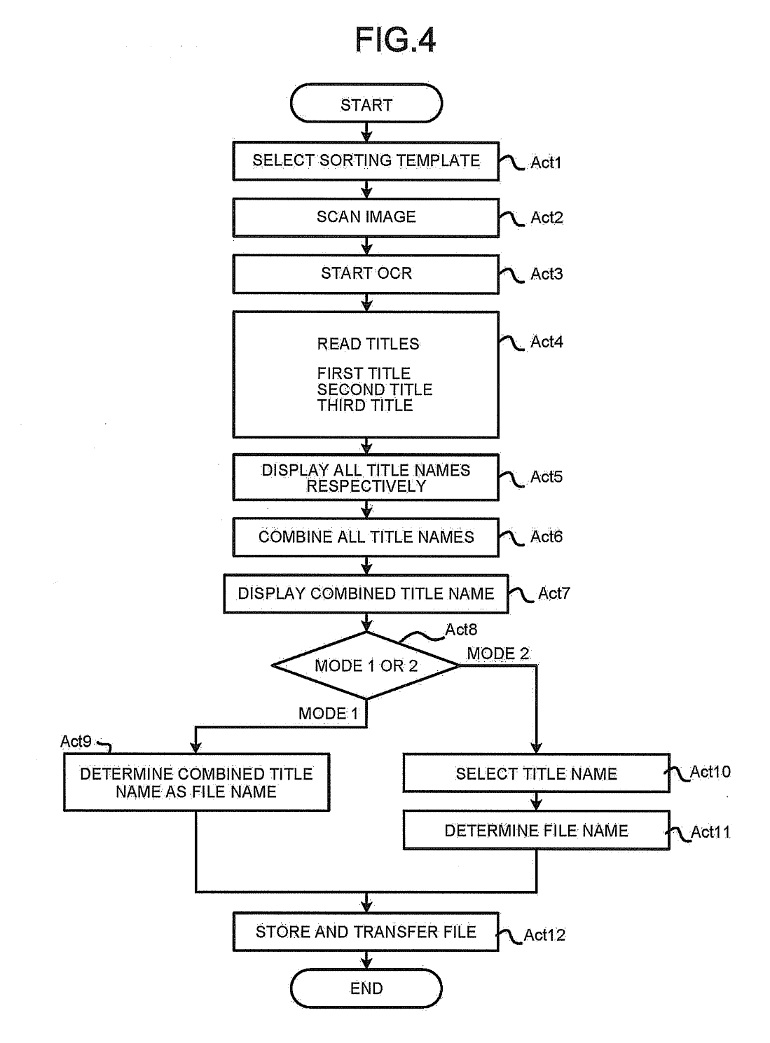

Sequentially, the aforementioned file name determination processing operation performed by the control section 5 is described below with reference to the flowchart of FIG. 4.

First, a sorting template is selected in ACT 1 from, for example, the plurality of template display sections 31-36 set on the title name display section 40 shown in FIG. 2. It is shown in FIG. 2 that the second template display section 32 is selected. As a template display section is touched, the flow proceeds to ACT 2.

In ACT 2, the scanner unit 2 is activated to start to scan the image of the original 50, and then the flow proceeds to ACT 3. Additionally, the scanned original may be a one-page original or a multi-page original, however, as an example, a one-page original is read herein.

In ACT 3, the OCR of the data processor 4 is activated to read the image, and then the flow proceeds to ACT 4.

In ACT 4, the first, second and third titles in the image data acquired in the image processing carried out on the original 50 are all read, and then the flow proceeds to ACT 5.

In ACT 5, the first, second and third titles are all respectively displayed on the first individual title display section 42, the second individual title display section 43 and the third individual title display section 44 shown in FIG. 2, and then the flow proceeds to ACT 6. At this time, the sorting title of the selected sorting template is displayed in front.

In ACT 6, the first title, the second title and the third title are all combined in sequence, and then the flow proceeds to ACT 7. At this time, the sorting title of the selected sorting template is placed in front.

In ACT 7, the combined title name is displayed on the combined title name display section 41 of the title name display section 40 shown in FIG. 2, and then the flow proceeds to ACT 8.

In ACT 8, it waits for a selection on the first or second mode. The flow proceeds to ACT 9 if the first mode is selected or to ACT 10 if the second mode is selected.

In ACT 9, the combined title name is determined as a file name, and then the flow proceeds to ACT 12.

In ACT 10, an individual title name is selected, in ACT 11, the selected individual title name is determined as a file name, and then the flow proceeds to ACT 12.

In ACT 12, the determined file name is added to the image data and stored in the storage section 6 and, if needed, transferred to an external server, then the processing is ended.

In the present embodiment, the file name determined by the first mode can represent the content of the original 50 accurately. Further, the file name determined by the second mode, since determined according to the judgment of a user, can represent the content of the original 50 accurately with a short word.

Further, the processing illustrated in FIG. 4 exemplarily illustrates the execution of a program pre-stored in a storage area of the storage section 6 of the MFP 1 by an internal data processor, however, the program may also be downloaded to the MFP from a network, or a device which stores the program in a computer-readable recording medium may also be installed in the MFP. The form of the recording medium is not limited as long as the recording medium can store programs and is readable by a computer. The recording medium may be, for example, a RAM (Random Access Memory), a ROM (Read Only Memory), a DRAM, an SRAM (Static Random Access Memory), a VRAM (Video RAM) and a flash memory.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A file management apparatus for managing a file name of a file of an image information based on the information of an original image read by a scanner unit, comprising:
an image processing section configured to carry out an image processing for the original image information read by the scanner unit;
a title name extraction section configured to extract a plurality of different individual title names based on the processing information processed by the image processing section;
a combined title name generation section configured to combine the plurality of individual title names extracted by the title name extraction section to generate a combined title name;
an individual title name selection section configured to select one individual title name from the plurality of individual title names extracted by the title name extraction section;
a file name determination section configured to select processes which determine the combined title name generated by the combined title name generation section as a file name or processes which determine the individual title name selected by the individual title name selection section as a file name and add the determined file name to the original image information; and
a storage section configured to store the original image information added with the determined file name.

2. The file management apparatus according to claim 1, further comprising:
a template section configured to add a name representing an attribution in front of the determined title name, wherein
the image information is stored in a folder arranged in the storage section corresponding to the attribution.

3. The file management apparatus according to claim 1, wherein
the individual title name selection section includes a plurality of individual title display sections for respectively displaying a plurality of individual title names and is capable of selecting one individual title name from the individual title names displayed on the plurality of individual title display sections.

4. The file management apparatus according to claim 1, wherein
the individual title name selection section selects characters of a high use frequency in the read original as the individual title name.

5. The file management apparatus according to claim 1, wherein
the scanner unit is arranged in a compound machine.

6. A file management method for managing a file name of a file of an image information based on the information of an original image read by a scanner unit, including:
carrying out an image processing for the original image information read by the scanner unit;
extracting a plurality of different individual title names based on the processed information;
combining the plurality of extracted individual title names to generate a combined title name;
selecting one individual title name from the plurality of extracted individual title names;
selecting processes which determine the generated combined title name as a file name or processes which determine the selected individual title name as a file name and adding the determined file name to the original image information; and
storing the original image information added with the determined file name.

7. The file management method according to claim 6, further including:
adding a name representing an attribution in front of the determined title name; and
storing the image information in a folder arranged in the storage section corresponding to the attribution.

8. The file management method according to claim 6, wherein
a plurality of individual title names are displayed on the individual title name selection section, and
one individual title name is selected from the individual title names displayed on the plurality of individual title display sections.

9. The file management method according to claim 6, wherein
a character of a high use frequency in the read original is selected as the individual title name.
